(19) United States
(12) Patent Application Publication
(10) Pub. No.: US 2009/0106647 A1
(43) Pub. Date: Apr. 23, 2009

(54) SYSTEM AND METHOD FOR CREATING SEASONALLY ADJUSTED GREETING CARDS VIA A KIOSK

(76) Inventors: Silvy J. WILSON, Rancho Santa Margarita, CA (US); Marianne L. Kodimer, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/874,296

(22) Filed: Oct. 18, 2007

(51) Int. Cl. G06F 17/24

(52) U.S. Cl. 715/243

(57) ABSTRACT

The subject application is directed to a system and method for creating seasonally adjusted tangible outputs via an associated kiosk. Template data associated with seasonal tangible output templates is first stored in a data storage associated with the kiosk. Each of the templates includes code data corresponding to an associated season. Date data is then received and tested against the code data. As a result of the testing of the received date data against the code data, a subset of the plurality of tangible output templates is isolated. Display data is then generated on an associated display in accordance with the isolated subset of tangible output templates.

### BACKGROUND OF THE INVENTION

The subject application is directed generally to shared document output devices, such as kiosks, for generating tangible documents. It is particularly suited to printing kiosks wherein users generate seasonally targeted tangible output.

Kiosks, such as custom greeting card kiosks, are becoming increasingly popular. Such kiosks eliminate cost and floor space associated with stocking and displaying a large variety of greeting cards. A typical kiosk will employ a computer having a memory for storing card design options, as well as a user interface such as a touch screen, display, keyboard or pointing device. A printer will generate a tangible card in accordance with user selections. There is also typically included a mechanism by which payment for producing a selected card is made.

Kiosks allow for customization of card design or content, as well as a means to fill a demand for infrequently used but important occasions, such as less popular religious holidays or other non-religious occasions. Finally, kiosks allow for electronic updating of card options or designs without loss of inventory or time to effect replacement.

While kiosks are advantageous for the reasons noted above, the large variety of occasions and card design or customization options can require a user to navigate through a large number of options to isolate or customize a card of choice.

### SUMMARY OF THE INVENTION

In accordance with one embodiment of the subject application, there is provided a system and method directed to shared document output devices for generating tangible documents.

Further, in accordance with one embodiment of the subject application, there is provided a system and method directed to a kiosk wherein users generate seasonally targeted tangible output.

Still further, in accordance with one embodiment of the subject application, there is provided a system for creating seasonally adjusted tangible output via an associated kiosk. The system is comprised of a data storage including means adapted for storing template data associated with a plurality of seasonal tangible output templates, wherein each tangible output template includes code data comprising code corresponding to a season associated therewith. The system also includes means adapted for receiving date data and testing means adapted for testing received date data against code data. The system further comprises means adapted for isolating a subset of the plurality of tangible output templates in accordance with an output of the testing means and a display data generator means adapted for generating display data on an associated display in accordance with an isolated subset of tangible output templates.

In one embodiment of the subject application, each tangible output template further includes subcategory data corresponding to a subcategory associated with the associated season, and wherein the display data generator means includes means adapted for generating the display data in accordance with subcategory data.

In another embodiment of the subject application, the display data generator means includes means adapted for generating the display data as an XML file adapted for display on an associated thin client.

In yet another embodiment of the subject application, the display generator means includes means adapted for generating display data corresponding to a plurality of tangible output templates independently of the testing means.

In a further embodiment of the subject application, the testing means includes means adapted for receiving holiday data corresponding to moving holiday dates and fixed holiday dates associated with each of a plurality of calendar years. The testing means also includes means adapted for testing received date information against code data and received holiday data. Preferably, moving holiday dates are selected from a set comprising Easter, Hanukkah, mother's day, father's day and wherein fixed holiday dates are selected from a set comprising, Christmas, Halloween, St. Patrick's Day, Valentine's Day, Kwanzaa, and New Year's Day.

In another embodiment of the subject application, the testing means includes means adapted for receiving date range data associated with each season and means adapted for testing received data information against code data, date range data, and received holiday data.

In yet another embodiment of the subject application, the display generator means includes means adapted for generating a secondary, isolated subset of tangible output templates associated with a season when an output of the testing means indicates that a critical date associated therewith has passed.

Still further, in accordance with one embodiment of the subject application, there is provided a method for creating seasonally adjusted tangible outputs via an associated kiosk in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for creating seasonally adjusted tangible outputs via a kiosk according to one embodiment of the subject application;

FIG. 2A is a view representing an output media storage tray for use in the system for creating seasonally adjusted tangible outputs via an associated kiosk according to one embodiment of the subject application;

FIG. 2B is a view representing a tangible output media for use in the system for creating seasonally adjusted tangible outputs via an associated kiosk according to one embodiment of the subject application;

FIG. 3 is a block diagram illustrating device hardware for use in the system for creating seasonally adjusted tangible outputs via an associated kiosk according to one embodiment of the subject application;

FIG. 4 is a functional diagram illustrating the device for use in the system for creating seasonally adjusted tangible outputs via an associated kiosk according to one embodiment of the subject application;

FIG. 5 is a block diagram illustrating controller hardware for use in the system for creating seasonally adjusted tangible outputs via an associated kiosk according to one embodiment of the subject application;

FIG. 6 is a functional diagram illustrating the controller for use in the system for creating seasonally adjusted tangible outputs via an associated kiosk according to one embodiment of the subject application;

FIG. 7 is a flowchart illustrating a method for creating seasonally adjusted tangible outputs via an associated kiosk according to one embodiment of the subject application; and

FIG. 8 is a flowchart illustrating a method for creating seasonally adjusted tangible outputs via an associated kiosk according to one embodiment of the subject application.

### DETAILED DESCRIPTION OF THE PREFERRED EMBODIMENT

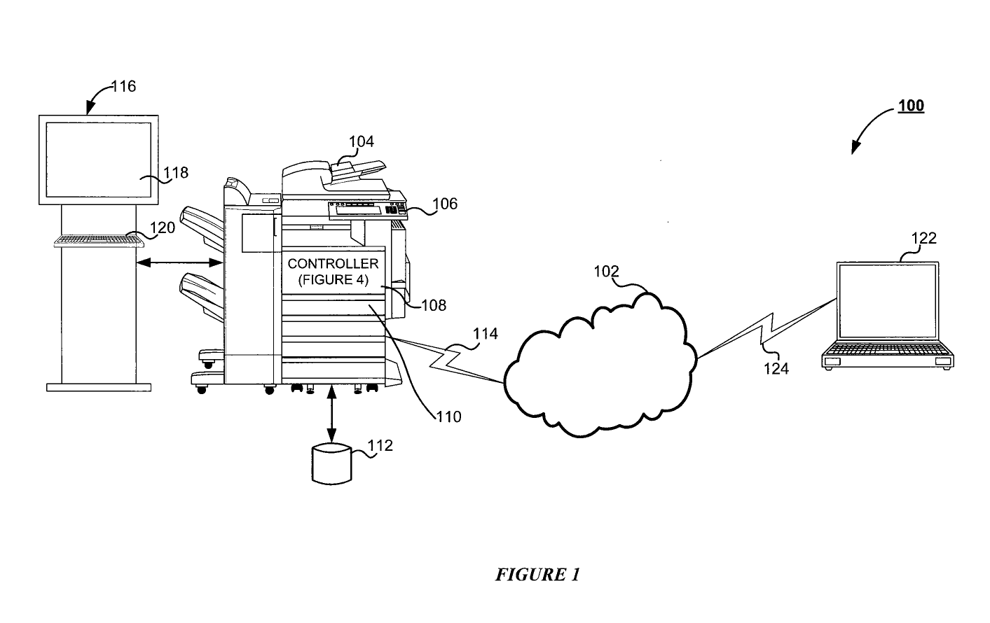

The subject application is directed to a system and method directed to shared document output devices for generating tangible documents. In particular, the subject application is directed to a system and method for creating seasonally adjusted tangible outputs via an associated kiosk. More particularly, the subject application is directed to a system and method directed to a kiosk wherein users generate seasonally targeted tangible output. It will become apparent to those skilled in the art that the system and method described herein are suitably adapted to a plurality of varying electronic fields employing dynamic update of templates, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a seasonally adjusted tangible output kiosk system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

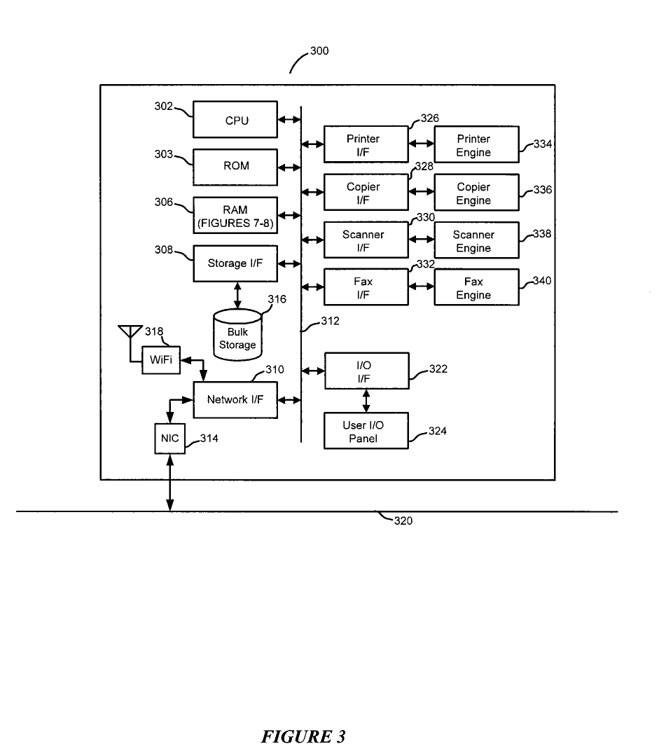

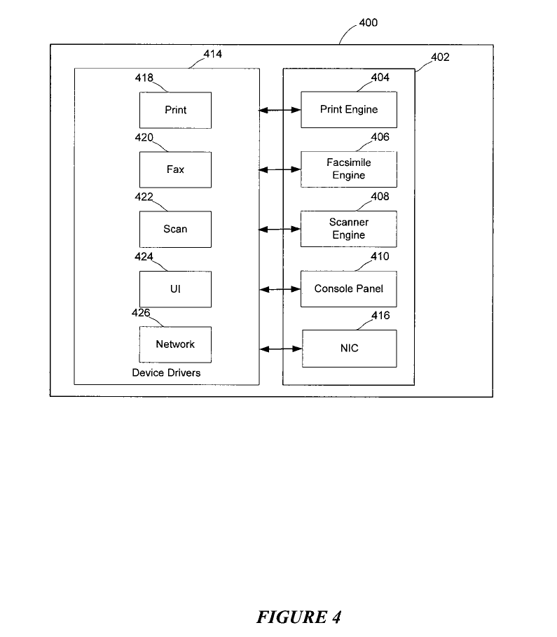

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 3 and 4, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 114. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

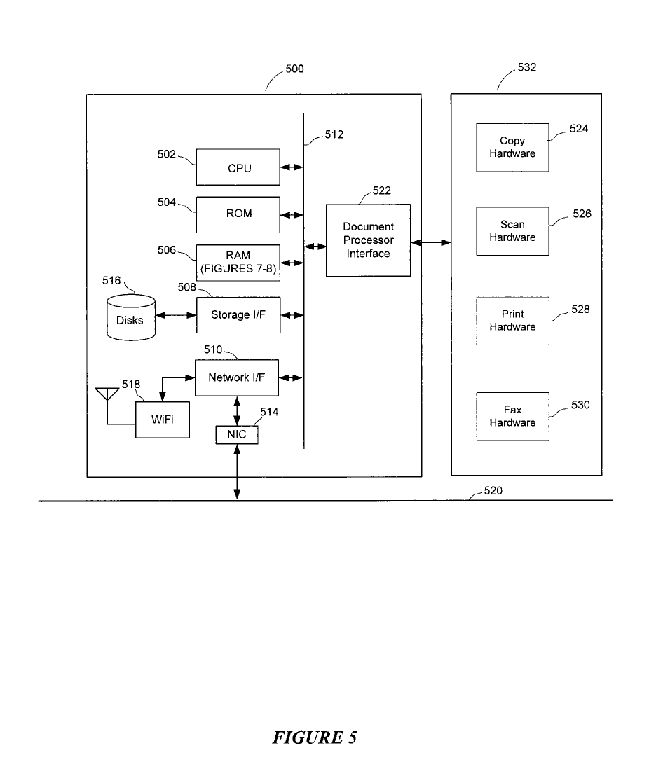

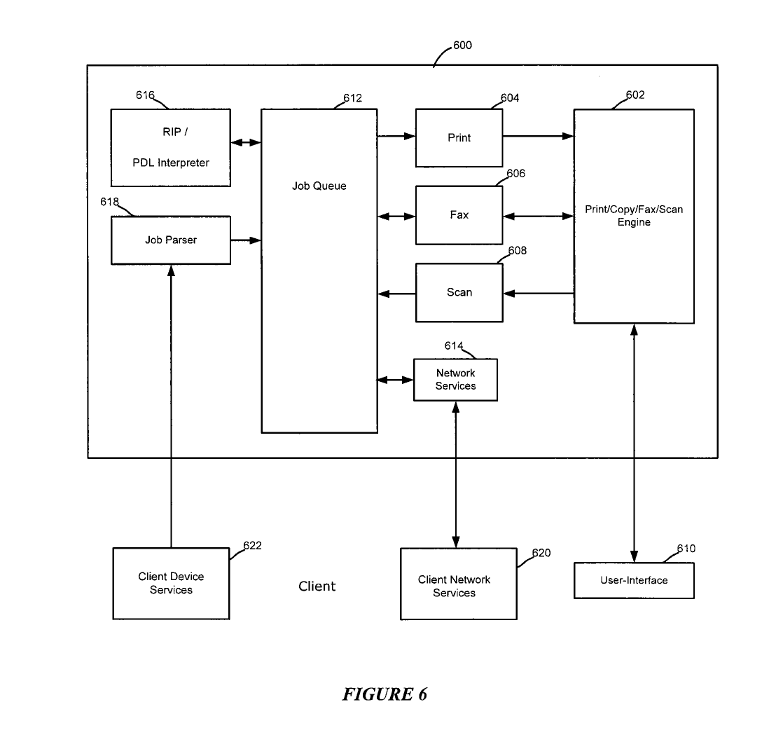

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for creating seasonally adjusted tangible outputs via an associated kiosk of the subject application. The functioning of the controller 108 will better be understood in conjunction with the block diagrams illustrated in FIGS. 5 and 6, explained in greater detail below.

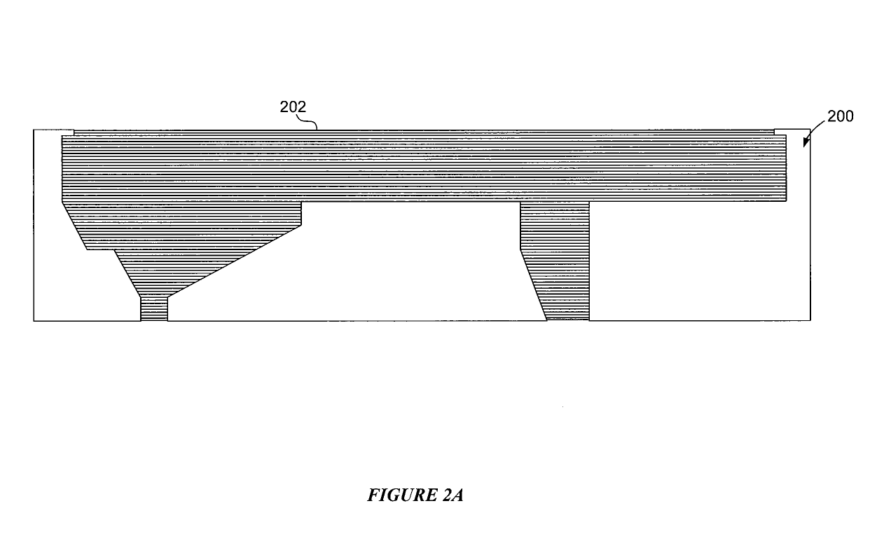

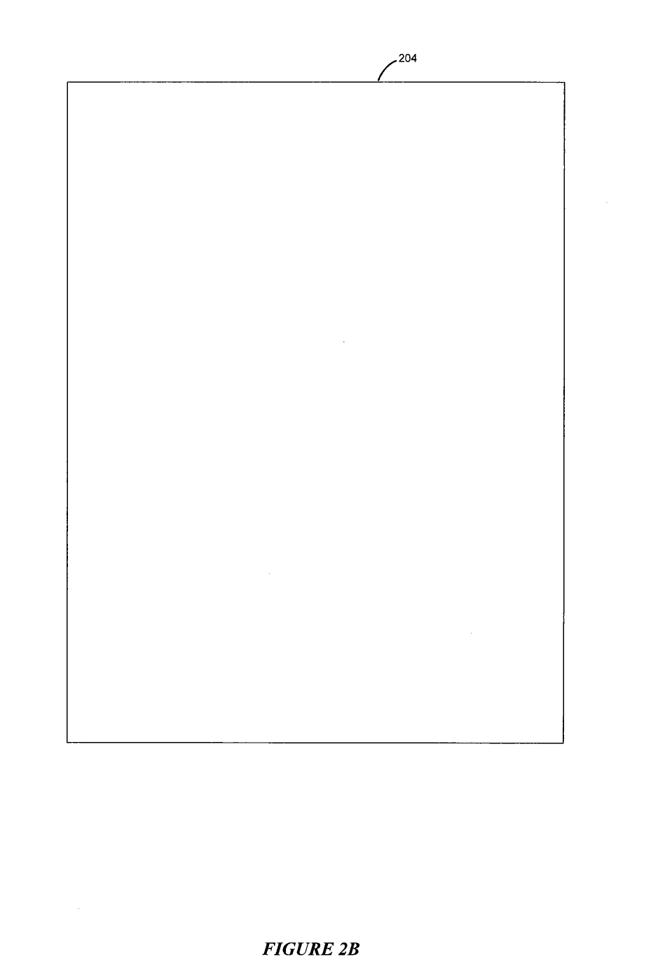

As depicted in FIG. 1, the document processing device 104 further includes one or more media storage trays 110, suitably configured to stored output media for output by the document processing device 110. The skilled artisan will appreciate that the media storage tray 110 is representative of any of a myriad of storage components associated with the document processing device 104 capable of storing sheets of paper of varying sizes, sheets of transparencies, blank greeting cards, blank business cards, photographic paper, or any other tangible output medium upon which documents or images are rendered. A close-up view of the media storage tray 110 is shown in FIG. 2A, discussed in greater detail below.

Communicatively coupled to the document processing device 104 is a data storage device 112. In accordance with the preferred embodiment of the subject application, the data storage device 112 is any mass storage devices known in the art including, for example and without limitation, magnetic storage drives, a hard disk drive, optical storage devices, flash memory devices, or any suitable combination thereof. In the preferred embodiment, the data storage device 112 is suitably adapted to store document data, image data, electronic database data, or the like. It will be appreciated by those skilled in the art that while illustrated in FIG. 1 as being a separate component of the system 100, the data storage device 112 is capable of being implemented as an internal storage component of the associated document processing device 104, a component of the controller 108, or the like, such as, for example and without limitation, an internal hard disk drive, or the like. In accordance with one embodiment of the subject application, the data storage device 112 is capable of storing tangible output templates, code data, seasonal data, holiday data, images, gift card formats, greeting card formats, fonts, and the like.

Illustrated in FIG. 1 is a kiosk 116, communicatively coupled to the document processing device 104, and in effect, the computer network 102. It will be appreciated by those skilled in the art that the kiosk 116 is capable of being implemented as a separate component of the document processing device 104, or as an integral component thereof. Use of the kiosk 116 in FIG. 1 is for example purposes only, and the skilled artisan will appreciate that the subject application is capable of implementation without the use of kiosk. In accordance with one embodiment of the subject application, the kiosk 116 includes a display 118 and a user input device 120. As will be understood by those skilled in the art the kiosk 116 is capable of implementing a combination user input device/display, such as a touch screen interface. According to one embodiment of the subject application, the kiosk 116 is suitably adapted to display prompts to an associated user, receive instructions from the associated user, receive payment data, receive selection data from the associated user, and the like. Preferably, the kiosk 116 is suitably adapted to receive a portable storage media, such as a magnetic card, which includes transaction identification data. In accordance with such an embodiment, the kiosk 116 includes a magnetic card reader, conventional bar code reader, or the like, suitably adapted to receive and read data from a portable storage device.

The system 100 illustrated in FIG. 1 further depicts a user device 122, in data communication with the computer network 102 via a communications link 124. It will be appreciated by those skilled in the art that the user device 122 is shown in FIG. 1 as a laptop computer for illustration purposes only. As will be understood by those skilled in the art, the user device 122 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 122 is suitably adapted to generate and transmit electronic documents, document processing instructions, user interface modifications, upgrades, updates, personalization data, or the like, to the document processing device 104, or any other similar device coupled to the computer network 102. In accordance with one embodiment of the subject application, the user device 122 includes a web browser application, suitably adapted to securely interact with the document processing device 104, or the like. The skilled artisan will appreciate that the user device 122 is also capable of implementation as an administrative device, whereupon a user associated with the device 122 is able to access, delete, view, or otherwise modify data stored on the data storage device 112 associated with the document processing device 104.

Referring now to FIG. 2A, there is shown a representation diagram illustrating a media storage tray 200 associated with the document processing device 104. As depicted in FIG. 2A, the storage tray 200 includes a plurality of output media 202, illustrated as paper output media in accordance with one embodiment of the subject application. It will be appreciated by those skilled in the art that the output media storage tray 200 of the subject application is capable of being configured to store any of a myriad of tangible output media known in the art including, for example and without limitation, paper, greeting card blanks, poster board, transparencies, business card blanks, envelopes, or the like. The skilled artisan will further appreciate that the output media 202 shown in FIG. 2A is capable of implementation in a plurality of various sizes, e.g., letter, ledger, A4, legal, A5, or the like, dependent upon the type and size of media available to associated document processing device 104. FIG. 2B illustrates a single sheet 204 corresponding to the tangible output media 202 of FIG. 2A upon which rendering by the document processing device 104 is output.

Turning now to FIG. 3, illustrated is a representative architecture of a suitable device 300, shown in FIG. 1 as the document processing device 104, on which operations of the subject system are completed. Included is a processor 302, suitably comprised of a central processor unit. However, it will be appreciated that the processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the device 300.

Also included in the device 300 is random access memory 306, suitably formed of dynamic random access memory, static random access memory, or any other suitable, addressable memory system. Random access memory provides a storage area for data instructions associated with applications and data handling accomplished by the processor 302.

A storage interface 308 suitably provides a mechanism for volatile, bulk or long term storage of data associated with the device 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the device 300 to communicate to other devices. The network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 314 is interconnected for data interchange via a physical network 320, suitably comprised of a local area network, wide area network, or a combination thereof.

Data communication between the processor 302, read only memory 304, random access memory 306, storage interface 308 and the network subsystem 310 is suitably accomplished via a bus data transfer mechanism, such as illustrated by bus 312.

Suitable executable instructions on the device 300 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 322 to a user input/output panel 324 as will be appreciated by one of ordinary skill in the art.

Also in data communication with bus 312 are interfaces to one or more document processing engines. In the illustrated embodiment, printer interface 326, copier interface 328, scanner interface 330, and facsimile interface 332 facilitate communication with printer engine 334, copier engine 336, scanner engine 338, and facsimile engine 340, respectively. It is to be appreciated that the device 300 suitably accomplishes one or more document processing functions. Systems accomplishing more than one document processing operation are commonly referred to as multifunction peripherals or multifunction devices.

Turning now to FIG. 4, illustrated is a suitable document processing device (shown in FIG. 1 as the document processing device 104) for use in connection with the disclosed system. FIG. 4 illustrates suitable functionality of the hardware of FIG. 3 in connection with software and operating system functionality as will be appreciated by one of ordinary skill in the art. The document processing device 400 suitably includes an engine 402 which facilitates one or more document processing operations.

The document processing engine 402 suitably includes a print engine 404, facsimile engine 406, scanner engine 408 and console panel 410. The print engine 404 allows for output of physical documents representative of an electronic document communicated to the processing device 400. The facsimile engine 406 suitably communicates to or from external facsimile devices via a device, such as a fax modem.

The scanner engine 408 suitably functions to receive hard copy documents and in turn image data corresponding thereto. A suitable user interface, such as the console panel 410, suitably allows for input of instructions and display of information to an associated user. It will be appreciated that the scanner engine 408 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 4, the document processing engine also comprises an interface 416 with a network via driver 426, suitably comprised of a network interface card. It will be appreciated that a network thoroughly accomplishes that interchange via any suitable physical and non-physical layer, such as wired, wireless, or optical data communication.

The document processing engine 402 is suitably in data communication with one or more device drivers 414, which device drivers allow for data interchange from the document processing engine 402 to one or more physical devices to accomplish the actual document processing operations. Such document processing operations include one or more of printing via driver 418, facsimile communication via driver 420, scanning via driver 422 and a user interface functions via driver 424. It will be appreciated that these various devices are integrated with one or more corresponding engines associated with the document processing engine 402. It is to be appreciated that any set or subset of document processing operations are contemplated herein. Document processors which include a plurality of available document processing options are referred to as multi-function peripherals.

Turning now to FIG. 5, illustrated is a representative architecture of a suitable backend component, i.e., the controller 500, shown in FIG. 1 as the controller 108, on which operations of the subject system 100 are completed. The skilled artisan will understand that the controller 500 is representative of any general computing device, known in the art, capable of facilitating the methodologies described herein. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration data, and other routines or data used for operation of the controller 500.

Also included in the controller 500 is random access memory 506, suitably formed of dynamic random access memory, static random access memory, or any other suitable, addressable and writable memory system. Random access memory provides a storage area for data instructions associated with applications and data handling accomplished by processor 502.

A storage interface 508 suitably provides a mechanism for non-volatile, bulk or long term storage of data associated with the controller 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the controller 500 to communicate to other devices. The network interface subsystem 510 suitably interfaces with one or more connections with external devices to the device 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network interface subsystem 510 is suitably accomplished via a bus data transfer mechanism, such as illustrated by bus 512.

Also in data communication with bus the 512 is a document processor interface 522. The document processor interface 522 suitably provides connection with hardware 532 to perform one or more document processing operations. Such operations include copying accomplished via copy hardware 524, scanning accomplished via scan hardware 526, printing accomplished via print hardware 528, and facsimile communication accomplished via facsimile hardware 530. It is to be appreciated that the controller 500 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 500 of FIG. 5, (shown in FIG. 1 as the controller 108) as an intelligent subsystem associated with a document processing device. In the illustration of FIG. 6, controller function 600 in the preferred embodiment, includes a document processing engine 602. A suitable controller functionality is that incorporated into the Toshiba e-Studio system in the preferred embodiment. FIG. 6 illustrates suitable functionality of the hardware of FIG. 5 in connection with software and operating system functionality as will be appreciated by one of ordinary skill in the art.

In the preferred embodiment, the engine 602 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 602 is suitably interfaced to a user interface panel 610, which panel allows for a user or administrator to access functionality controlled by the engine 602. Access is suitably enabled via an interface local to the controller, or remotely via a remote thin or thick client.

The engine 602 is in data communication with the print function 604, facsimile function 606, and scan function 608. These functions facilitate the actual operation of printing, facsimile transmission and reception, and document scanning for use in securing document images for copying or generating electronic versions.

A job queue 612 is suitably in data communication with the print function 604, facsimile function 606, and scan function 608. It will be appreciated that various image forms, such as bit map, page description language or vector format, and the like, are suitably relayed from the scan function 608 for subsequent handling via the job queue 612.

The job queue 612 is also in data communication with network services 614. In a preferred embodiment, job control, status data, or electronic document data is exchanged between the job queue 612 and the network services 614. Thus, suitable interface is provided for network based access to the controller function 600 via client side network services 620, which is any suitable thin or thick client. In the preferred embodiment, the web services access is suitably accomplished via a hypertext transfer protocol, file transfer protocol, uniform data diagram protocol, or any other suitable exchange mechanism. The network services 614 also advantageously supplies data interchange with client side services 620 for communication via FTP, electronic mail, TELNET, or the like. Thus, the controller function 600 facilitates output or receipt of electronic document and user information via various network access mechanisms.

The job queue 612 is also advantageously placed in data communication with an image processor 616. The image processor 616 is suitably a raster image process, page description language interpreter or any suitable mechanism for interchange of an electronic document to a format better suited for interchange with device functions such as print 604, facsimile 606 or scan 608.

Finally, the job queue 612 is in data communication with a parser 618, which parser suitably functions to receive print job language files from an external device, such as client device services 622. The client device services 622 suitably include printing, facsimile transmission, or other suitable input of an electronic document for which handling by the controller function 600 is advantageous. The Parser 618 functions to interpret a received electronic document file and relay it to the job queue 612 for handling in connection with the afore-described functionality and components.

In operation, template data associated with seasonal tangible output templates is first stored, with each template including code data corresponding to an associated season. Date data is then received and tested against the code data. Thereafter, a subset of the plurality of tangible output templates is isolated according to the results of the testing of the received date data against the code data. Display data is then generated on an associated display in accordance with the isolated subset of tangible output templates.

In accordance with one example embodiment of the subject application, the kiosk 116, controller 108, or other suitable component associated with the document processing device 104 first receives and stores tangible output template data via the data storage device 112. According to one embodiment of the subject application, the template data includes code data corresponding to an associated season, e.g., Christmas, Kwanzaa, Halloween, Thanksgiving, or a myriad of other holidays, seasons, date-specific occasions, as will be appreciated by those skilled in the art. It will further be appreciated by those skilled in the art that each tangible output template is further capable of including subcategory data corresponding to a subcategory associated with the associated season.

Thereafter, the kiosk 116 or controller 108 receives holiday data corresponding to fixed and moving holiday dates. For example, moving holiday dates include Easter, Hanukkah, mother's day, father's day and the like, while fixed holiday dates include Christmas, Halloween, St. Patrick's Day, Valentine's Day, Kwanzaa, and New Year's Day. Preferably, the holiday data is stored in the data storage device 112 accessible by the controller 108, the kiosk 116, or other suitable component associated with the document processing device 104. Date range data associated with each season is then received by the controller 108 or other suitable component associated with the document processing device 104 and is stored in the data storage device 112. The skilled artisan will appreciate that the date range data corresponds to a pre-selected period associated with the given season, or holiday. For example, date range data associated with the Christmas holiday, or season, corresponds to a range from December 1 to December 25, or the like. It will be understood by those skilled in the art that the range for a given season, or holiday, is capable of being determined based upon administrator settings, regional settings, national holidays, or the like. In accordance with one embodiment of the subject application, the received data is stored on the data storage device 112 in an extensible markup language (XML) document readily understood by the controller 108, the kiosk 116, a thin client associated with the user device 122, or the like.

Date data is then received corresponding to the current date. That is, the controller 108, kiosk 116, or other suitable component associated with the document processing device 104 ascertains the current date. Thereafter, the date information, e.g., the received date data, is then tested by the controller 108, kiosk 116, or other suitable component associated with the document processing device 104 against the code data, the date range data, and the received holiday data. Preferably, the controller 108, kiosk 116, or suitable thin client associated with the user device 122, retrieves the aforementioned data from the data storage device 112 and determines the seasons associated therewith.

A determination is then made whether a critical date associated with the determined season has passed. For example, whether a holiday date, e.g., December 25, has passed, thereby indicating that the Christmas holiday season has passed. When the critical date associated with the determined season has not yet passed, a subset of tangible output templates associated with season, as based upon the code data, is then retrieved from the data storage device 112 by the kiosk 116, the controller 108, the thin client associated with the user device 122, or the like. Display data associated with the isolated subset of tangible output templates is then generated on the display 118 associated with the kiosk 116, the user interface 106 associated with the document processing device 104, the thin client associated with the user device 122, or the like.

The kiosk 116, controller 108, or the like, then determines whether any additional seasons associated with the received date data remain in the data storage device 112. Continuing with the above example, a determination that the date is December 1 would indicate that at least Hanukkah, which typically falls in December, is also capable of having a date range, depending upon the year, that indicates that the Hanukkah season also corresponds to the received date data.

A determination is then made whether a critical date associated with the Hanukkah season has occurred, such as, whether the Hanukkah has already ended. When it is determined that the season has ended, a secondary subset of tangible output templates, e.g., belated tangible output templates, is then isolated associated with the season. Display data associated with the secondary isolated subset of tangible output templates is then generated via the display 118, the user interface 106, the thin client associated with the user device 122, or the like.

When no additional seasons remain, based upon the testing of the received date data, display data associated with independent tangible output templates, e.g., birthday, get well, congratulatory, anniversary, sympathy, or the like, is then generated via the associated display 118, user interface 106, thin client associated with the user device 122, or the like. Preferably, a graphical user interface is generated on the associated display to an associated user corresponding to the generated display data of the tangible output templates.

Selection data is then received from a user selection of a desired tangible output template for output on the associated document processing device 104. The user is then prompted for customization data corresponding to the customization of the selected tangible output template. The received customization data is then incorporated into the selected template via the controller 108, kiosk 116, or other suitable component associated with the document processing device 104. In accordance with one embodiment of the subject application, the controller 108, kiosk 116, or the like, generates a graphical representation of the selected template, along with the customization data, to the user for user approval. Cost data associated with the output of the customized tangible output template is then generated by the controller 108, kiosk 116, or the like. The cost data is then displayed to the user via the associated display for approval thereon. Upon receipt of payment, the document processing device 104 outputs the customized tangible output template, such as, for example and without limitation, a customized greeting card, banner, poster, or the like.

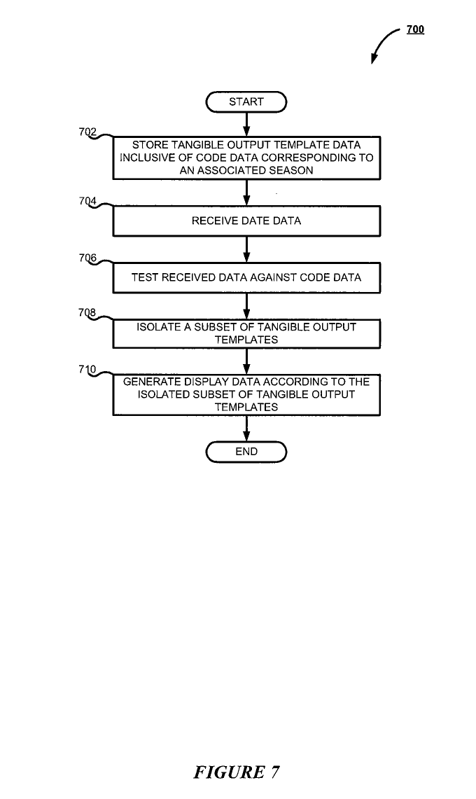

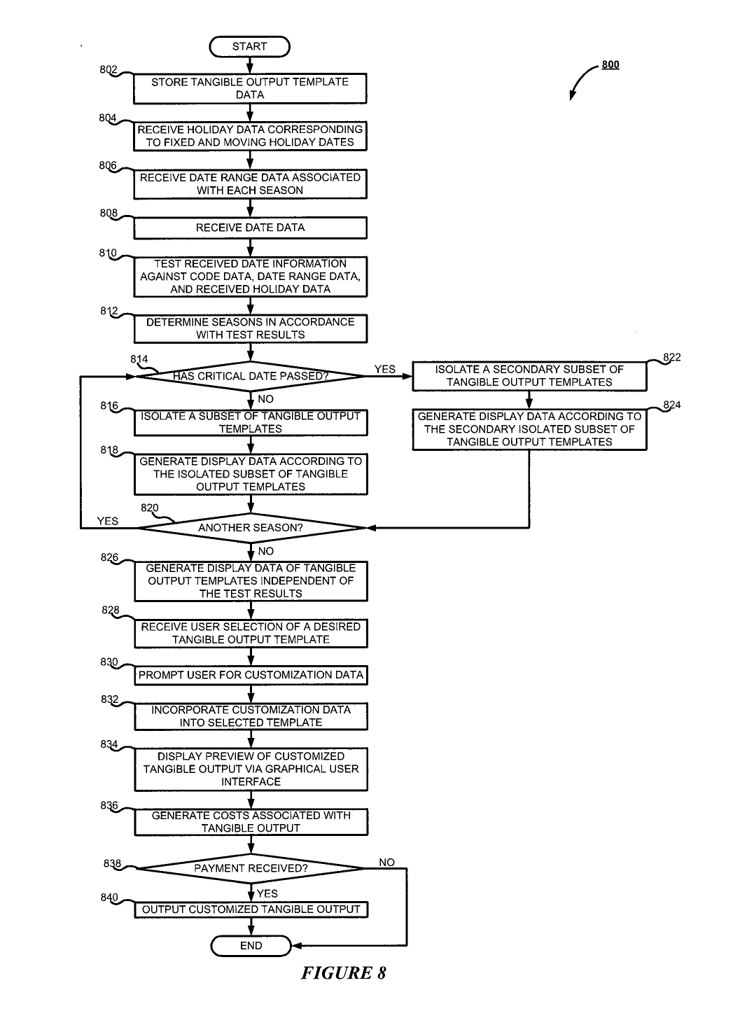

The skilled artisan will appreciate that the subject system 100 and components described above with respect to FIG. 1, FIG. 2A, FIG. 2B, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for creating seasonally adjusted tangible output via an associated kiosk in accordance with one embodiment of the subject application. Beginning at step 702, the kiosk 116, the controller 108, or other suitable component associated with the document processing device 104, receives tangible output template data associated with a plurality of seasonal tangible output templates. Preferably, the each of the received tangible output templates includes code data corresponding to a season associated with the template. For example, when the tangible output template is a greeting card, one template includes code data indicating the card corresponds to Christmas, a second template includes code data indicating the card corresponds to mother's day, and a third template includes code data indicating the card corresponds to Halloween.

In accordance with one embodiment of the subject application, the kiosk 116, controller 108, or the like, receives the template data from an administrator via the user device 122. It will be appreciated by those skilled in the art that the kiosk 116, controller 108, or the like, is capable of storing the received tangible output template data via the data storage device 112. It will be further appreciated by the skilled artisan that the data storage device 112 is capable of storing a variety of tangible output templates, each of which is capable of being associated with a particular holiday, occasion, or the like. According to one particular embodiment of the subject application, each of the tangible output templates is accessible by the kiosk 116, the user interface 106, a thin client interface associated with the user device 122, or the like, for output by the document processing device 104, as will be understood by those skilled in the art.

At step 704, date data is received by the kiosk 116, the controller 108, or other suitable component associated with the document processing device 104. For example, the current date upon which an associated user is requesting the output of a customized tangible output template using a suitable template available on the data storage device 112 for output by the document processing device 104. The received date data is then tested against the code data associated with each tangible output template stored in the data storage device 112 at step 706. A subset of those output templates stored on the data storage device 112 is then isolated by the controller 108, the kiosk 116, or other suitable component associated with the document processing device 104 at step 708 based upon the output of the date data/code data test. Display data is then generated at step 710 on the display 118, the user interface 106, the user device 122, or other suitable display associated with the document processing device 104 in accordance with the isolated subset of tangible output templates.

Referring now to FIG. 8, there is shown a flowchart 800 illustrating a method for creating seasonally adjusted tangible outputs via an associated kiosk in accordance with one embodiment of the subject application. The methodology depicted in FIG. 8 begins at step 802, whereupon the kiosk 116, controller 108, or other suitable component associated with the document processing device 104 first receives and stores tangible output template data via the data storage device 112. In accordance with one embodiment of the subject application, the tangible output template data further includes code data representative of an associated season, such as, for example and without limitation, Christmas, Kwanzaa, Halloween, Thanksgiving, or other holiday seasons, as will be understood by those skilled in the art. In addition, each tangible output template is further capable of including subcategory data corresponding to a subcategory associated with the associated season. It will be appreciated by those skilled in the art that an associated user is capable of interacting with the document processing device 104 via the kiosk 116, the user interface 106, a thin client associated with the user device 122, or the like. Thus, the skilled artisan will understand that the mythology described with respect to FIG. 8, particularly the user interactions, is capable of occurring on any suitable electronic device, e.g., the kiosk 116 or the user device 122, in data communication with the document processing device 104.

At step 804, holiday data corresponding to fixed holiday dates and moving holiday dates is received by the controller 108, kiosk 116, or other suitable component associated with the document processing device 104. Suitable examples of moving holiday dates includes, without limitation, Hanukkah, Easter, mother's day, father's day, Thanksgiving, and the like. Examples of fixed holiday dates include, without limitation, Christmas, Halloween, St. Patrick's Day, Valentine's Day, Kwanzaa, New Year's Day, and the like. At step 806, date range data associated with each season is then received by the controller 108, kiosk 116, or the like. The skilled artisan will appreciate that the date range data corresponds to a pre-selected period associated with the given season, or holiday. For example, date range data associated with the Christmas holiday, or season, corresponds to a range from December 1 to December 25, or the like. It will be understood by those skilled in the art that the range for a given season, or holiday, is capable of being determined based upon administrator settings, regional settings, national holidays, or the like. In accordance with one embodiment of the subject application, the received date data, holiday data, etc., is stored in association with the tangible output templates on the data storage device 112, which is accessible by the controller 108, the kiosk 116, or other suitable component associated with the document processing device 104. According to one embodiment of the subject application, the received data is stored on the data storage device 112 in an extensible markup language (XML) document readily understood by the controller 108, the kiosk 116, a thin client associated with the user device 122, or the like. Flow then proceeds to step 808, whereupon date data is then received by the controller 108, kiosk 116, or other suitable component associated with the document processing device 104.

At step 810, date information, inclusive of the received date data, is tested by the controller 108, kiosk 116, or other suitable component associated with the document processing device 104 against the code data, the date range data, and the received holiday data stored in the associated data storage device 112. The controller 108, kiosk 116, or other suitable component associated with the document processing device 104 then ascertains, at step 812, which the seasons, as represented by the stored tangible output templates, correspond to the received date data.

The controller 108, kiosk 116, or the like then determines, at step 814, whether a critical date associated with the determined season has passed. Upon a determination that a critical date associated with the determined season has not yet passed, flow proceeds to step 816. At step 816, a subset of tangible output templates associated with the determined season, based upon the code data associated therewith, are isolated, e.g., retrieved, from the data storage device 112. The controller 108, kiosk 116, user device 122, or the like, then generates, at step 818, display data corresponding to the isolated subset of tangible output templates. Preferably, the display data corresponds to an XML document readily interpreted by the associated devices for display thereon.

Following such generation of display data at step 818, flow proceeds to step 820. At step 820, a determination is made whether another season was determined at step 812. That is, whether one or more additional seasons resulted from the testing. Upon a determination that another season was determined, flow returns to step 814, whereupon a determination is made whether a critical date associated with the season has passed. When the critical date associated with the season has passed, a secondary subset of tangible output templates is isolated at step 822. Thereafter, display data corresponding to the secondary isolated subset of tangible output templates is generated at step 824. In accordance with one embodiment of the subject application, the secondary isolated subset of tangible output templates corresponds to belated greetings, e.g., belated Christmas greeting, belated Hanukkah greeting, belated mother's day greeting, and the like. Flow then returns to step 820 for a determination on whether any additional seasons were determined at step 812.

For example, when the date data received corresponds to a date in December, the test results indicate that the Christmas season, the Hanukkah season, and the Kwanzaa season date ranges correlate with the received date data. With respect to each of these seasons, a determination is made whether a critical date has passed. Thus, for the Christmas season, whether the 25th of December has passed, for Kwanzaa, whether the 1st of January has passed, and for Hanukkah, whether the last day of the festival has passed. For each of these seasons, tangible output templates, such as greeting cards, banners, posters, pictures, and the like, are retrieved from the data storage device 112 and display data is thereafter generated.

Returning to the methodology of FIG. 8, when no further seasons were determined at step 820, flow proceeds to step 826. At step 826, display data of tangible output templates independent of the determined season(s) is generated by the controller 108, kiosk 116, or other suitable component associated with the document processing device 104. The skilled artisan will appreciate that such independent tangible output templates stored on the data storage device 112 include, for example and without limitation, birthday templates, anniversary templates, graduation templates, well cards templates, sympathy templates, and the like.

According to one embodiment of the subject application, the generated display data is then displayed to an associated user via the display 118, the user interface 106, the thin client associated with the user device 122, or the like, dependent upon the device 116, 104, 122 from which the user is accessing the method 800. It will be appreciated by those skilled in the art that such a display is capable of comprising, for example and without limitation, a suitable graphical user interface. User selection of a desired tangible output template is then received by the associated device 116, 104, 122 at step 828. The user is then prompted at step 830, via the associated graphical user interface, for customization data corresponding to customized features, options, or the like, associated with the tangible output template.

The received customization data is then incorporated into the selected tangible output template at step 832. A preview image corresponding to the tangible output template inclusive of the customization data is then displayed to the user at step 834 via the display 118, the user interface 106, the thin client interface of the user device 122, or the like. The controller 108 then generates, at step 836, the costs or charges associated with the output of the customized tangible output template. It will be appreciated by those skilled in the art that the costs are capable of being calculated based upon the type of output media 204 selected, toner requirements, resource requirements, resolution, and the like. A determination is then made at step 838 whether payment corresponding to the costs has been received from the user. That is, whether the user has provided credit card data, currency, billing account, prepaid account data, or the like, covering the costs associated with the output of the customized tangible output template. Upon receipt of payment form the associated user, the document processing device 104 outputs the customized template at step 840. A cancellation of the operation, or lack of payment, prompts the document processing device 104 to disregard the operation, whereupon the methodology of FIG. 8 terminates.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A seasonally adjusted printing kiosk system comprising:
a data storage including means adapted for storing template data associated with a plurality of seasonal tangible output templates, wherein each tangible output template includes code data comprising code corresponding to a season associated therewith;
means adapted for receiving date data;
testing means adapted for testing received date data against code data;
means adapted for isolating a subset of the plurality of tangible output templates in accordance with an output of the testing means; and
a display data generator means adapted for generating display data on an associated display in accordance with an isolated subset of tangible output templates.

2. The system of claim 1 wherein each tangible output template further includes subcategory data corresponding to a subcategory associated with the associated season, and wherein the display data generator means includes means adapted for generating the display data in accordance with subcategory data.

3. The system of claim 1 wherein the display data generator means includes means adapted for generating the display data as an XML file adapted for display on an associated thin client.

4. The system of claim 1 wherein the display generator means includes means adapted for generating display data corresponding to a plurality of tangible output templates independently of the testing means.

5. The system of claim 1 wherein the testing means further includes:
means adapted for receiving holiday data corresponding to moving holiday dates and fixed holiday dates associated with each of a plurality of calendar years; and
means adapted for testing received date information against code data and received holiday data.

6. The system of claim 5 wherein moving holiday dates are selected from a set comprising Easter, Hanukkah, mother's day, father's day and wherein fixed holiday dates are selected from a set comprising, Christmas, Halloween, St. Patrick's Day, Valentine's Day, Kwanzaa, and New Year's Day.

7. The system of claim 5 wherein the testing means further includes:
means adapted for receiving date range data associated with each season; and
means adapted for testing received data information against code data, date range data, and received holiday data.

8. The system of claim 5 further wherein the display generator means includes means adapted for generating a secondary, isolated subset of tangible output templates associated with a season when an output of the testing means indicates that a critical date associated therewith has passed.

9. A method for creating a seasonally adjusted tangible output via an associated kiosk comprising the steps of:
storing template data associated with a plurality of seasonal tangible output templates, wherein each tangible output template includes code data comprising code corresponding to a season associated therewith;
receiving date data;
testing received date data against code data;
isolating a subset of the plurality of tangible output templates in accordance with an output of the testing; and
generating display data on an associated display in accordance with an isolated subset of tangible output templates.

10. The method of claim 9 wherein each tangible output template further includes subcategory data corresponding to a subcategory associated with the associated season, and wherein the step of generating display data is in accordance with subcategory data.

11. The method of claim 9 wherein the display data is generated as an XML file adapted for display on an associated thin client.

12. The method of claim 9 wherein the step of generating includes generating display data corresponding to a plurality of tangible output templates independently of the output of the testing.

13. The method of claim 9 wherein the step of testing received date data includes:
receiving holiday data corresponding to moving holiday dates and fixed holiday dates associated with each of a plurality of calendar years; and
testing received date information against code data and received holiday data.

14. The method of claim 13 wherein moving holiday dates are selected from a set comprising Easter, Hanukkah, mother's day, father's day and wherein fixed holiday dates are selected from a set comprising, Christmas, Halloween, St. Patrick's Day, Valentine's Day, Kwanzaa, and New Year's Day.

15. The method of claim 13 wherein the step of testing received date data includes:
receiving date range data associated with each season; and
testing received data information against code data, date range data, and received holiday data.

16. The method of claim 13 further wherein the step of generating display data includes generating a secondary, isolated subset of tangible output templates associated with a season when an output of the testing indicates that a critical date associated therewith has passed.
